(19) United States
(12) Patent Application Publication
(10) Pub. No.: US 2017/0004157 A1
(43) Pub. Date: Jan. 5, 2017

(54) COLUMN STORE DATABASE COMPRESSION

(71) Applicant: HEWLETT PACKARD ENTERPRISE DEVELOPMENT LP, Houston, TX (US)

(72) Inventors: Ramakrishna Raghavendran Varadarajan, Cambridge, MA (US); James Laurence Finnerty, Cambridge, MA (US)

(21) Appl. No.: 15/125,681

(22) PCT Filed: Mar. 14, 2014
(86) PCT No.: PCT/US2014/029046

§ 371 Date: Sep. 13, 2016

(51) Int. Cl. G06F 17/30

(52) U.S. Cl. CPC G06F 17/30315; G06F 17/30339; G06F 17/30598

(57) ABSTRACT

Described are methods for data compression of a column store database. A method may include providing a plurality of columns sorted from a first position to a last position in increasing order of individual cardinality, permuting columns of the plurality of columns one-by-one to a second position of the plurality of columns, except for the column at the first position, to determine a first permutation of the plurality of columns having the greatest run-length encoding (RLE) compression, and permuting columns of the first permutation one-by-one to a third position, except for columns at the second position and the first position, to determine a second permutation having the greatest RLE compression. The method may further include continuing permuting the plurality of columns to determine a final sort order, and compressing columns of the final sort order using RLE compression.

### BACKGROUND

Databases are organized collections of data that can include a collection of records, each record having data pertaining to multiple fields or parameters. Some databases may be represented as a table in which the rows correspond to records and the columns correspond to fields. The intersection of a record (row) and field (column) is termed a “cell” and typically stores the value for a field parameter for a particular database record. Other database types, e.g., relational, hierarchical, and network databases, can have multiple related tables, each with records, fields, and cells.

While some databases may have only a few cells, others may have over a billion. The amount of data contained in databases may vary significantly. To reduce the amount of physical storage required for database, databases can be compressed.

### BRIEF DESCRIPTION OF THE DRAWINGS

The detailed description section references the drawings, wherein:

FIG. 1 is a block diagram of an example system endowed with a database manager to compress a column store database of the system;

FIG. 2 is a flowchart of an example method for compressing data in a column store database;

FIG. 3 is a flowchart of another example method for compressing data in a column store database; and

FIG. 4 is a block diagram showing an example tangible, non-transitory, machine-readable medium that stores code adapted to compress data is a column store database;

all in which various embodiments may be implemented.

Examples are shown in the drawings and described in detail below. The drawings are not necessarily to scale, and various features and views of the drawings may be shown exaggerated in scale or in schematic for clarity and/or conciseness. The same part numbers may designate the same or similar parts throughout the drawings.

### DETAILED DESCRIPTION OF EMBODIMENTS

In a column-organized database (a “column store”), tabular data may be organized into projections that have a specific sort order, and data may be physically clustered by column, As a result of the sort order, non-unique columns appearing early in the sort order may have an opportunity for run-length encoding. In some cases, the columns may include a number of correlated pairs or sets of columns, which may also provide an opportunity for run-length encoding to provide even further data compression.

Described herein are various implementations of methods, systems, and computer-readable media for data compression of a column store database. A method may include permuting the columns within a sorted projection to exploit correlations among the columns, and thereby to achieve greater run-length encoding (RLE) compression. In some implementations, the method may include sorting a plurality of columns from a first position to a last position in increasing order of individual cardinality, permuting columns of the plurality of columns one-by-one to a second position of the plurality of columns, except for columns at the first position, to determine a first permutation of the plurality of columns having the greatest RLE compression, and permuting columns of the first permutation one-by-one to a third position, except for columns at the second position and any preceding position, to determine a second permutation having the greatest RLE compression. The method may further include continuing permuting the plurality of columns to determine a final sort order, and compressing columns of the final sort order using RLE compression.

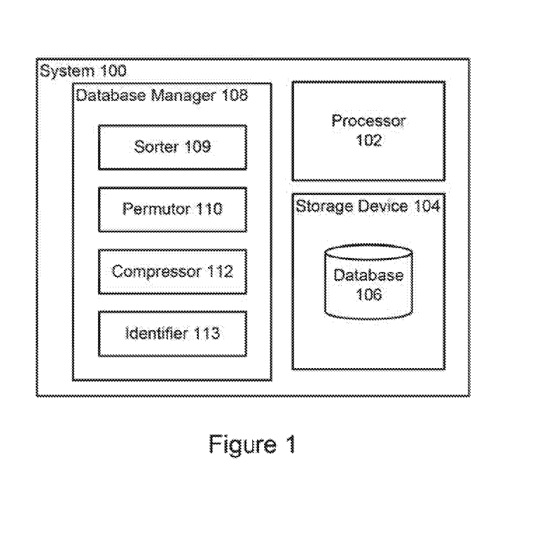

Referring now to the drawings, FIG. 1 is a block diagram of an example system 100 including a processor 102 and a storage device 104 to store a database 106 comprising a plurality of columns of data. The system 100 further includes a database manager 108 to manage the database 106. The database manager 108 may include permutor 110 and a compressor 112. In various implementations, the storage device 104 may include the database manager 108. In various implementations, the system 100 may be implemented as one or more computing devices. The storage device 104 may comprise a magnetic medium, like one or more hard disk drives.

In operation, the database manager 108 may be executable by the processor 102 to implement a method for data compression of the database 106. In various implementations, the permutor 110 may permute columns of the database 106 one-by-one into a final sort order, in accordance with the various implementations described herein, and the compressor 112 may compress the columns of the final sort order using RLE compression. For example, in some implementations, the permutor 110 may permute columns of the plurality of columns one-by-one to a second position of the plurality of columns, except for the column at the first position, to determine a first permutation of the plurality of columns having an RLE compression greater than an RLE compression of any other permutation. The permute 110 may continue, for example, with permuting columns of the first permutation one-by-one to a third position of the plurality of columns, except for columns at the second position and any preceding position, to determine a second permutation of the plurality of columns having an RLE compression greater than an RLE compression of any other permutation. In various implementations, a sorter 109 maysort the plurality of columns from the first position to a last position in increasing order of individual cardinality. In some implementations, an identifier 113 may identify correlated column pairs from the plurality of columns of the database 106 and store in memory, such as, for example, the storage device 104, correlated pairs having correlation strength values greater than a predetermined value. In these latter implementations, the stored correlated pairs may be referenced later by the database manager 108 or other component of the system 100 to facilitate looking up data, in response to a query, for example.

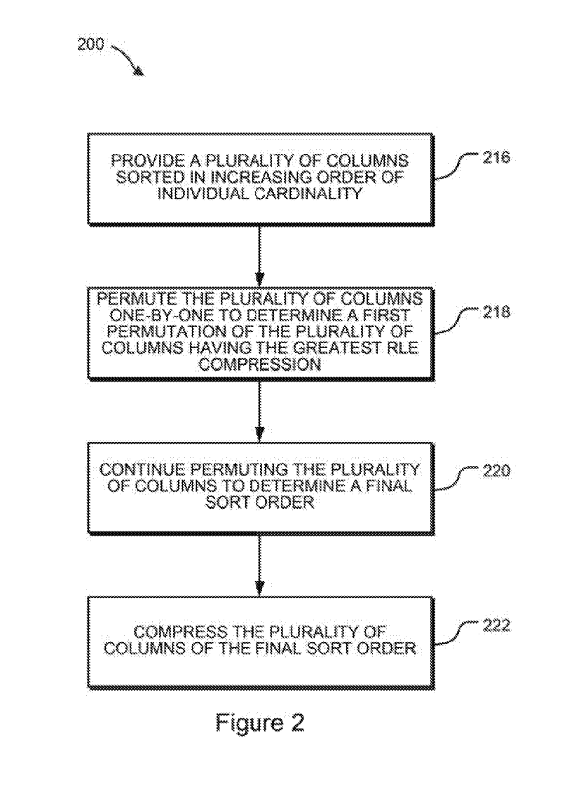

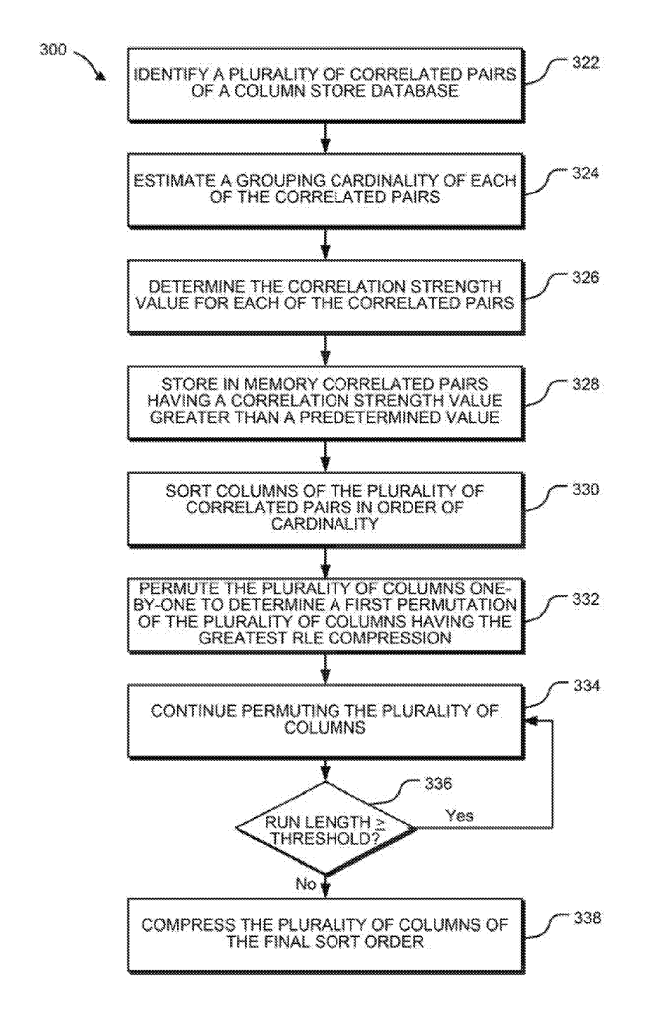

FIGS. 2 and 3 are flowcharts of example methods 200, 300, respectively, for compressing data in a column store database, in accordance with various implementations. It should be noted that various operations discussed and/or illustrated may be generally referred to as multiple discrete operations in turn to help in understanding various implementations. The order of description should not be construed to imply that these operations are order dependent, unless explicitly stated. Moreover, some implementations may include more or fewer operations than may be described.

As shown in FIG. 2, the method 200 may begin or proceed with providing a plurality of columns sorted from a first position, I=1, to a last position in increasing order of individual cardinality at block 216.

The method 200 may proceed to block 218 with permuting columns of the plurality of columns one-by-one to a second position of the plurality of columns, except for the column at the first position, to determine a first permutation of the plurality of columns having an RLE compression greater than an RLE compression of any other permutation, whereby RLE compression is a factor of grouping cardinalities at each position, the column data types, column width, or correlations, or a combination thereof. The method 200 may continue to block 220 with continuing permuting the plurality of columns to determine a final sort order.

The method 200 may proceed to block 222 with compressing the plurality of columns of the final sort order.

Turning now to FIG. 3, the method 300 may begin or proceed with identifying a plurality of correlated pairs a column store database at block 322. In various implementations, correlated pairs of columns may be identified using a “correlation detection via sampling” (CORDS) technique (“CORDS: Automatic Discovery of Correlation and Soft Functional Dependencies” by Ihab F. Ilyas et al.) or another suitable technique.

The method 300 may proceed with determining the correlation strength value of the correlated pairs by estimating a grouping cardinality of each pair of the correlated pairs at block 324 and determining, for each of the correlated pairs, the correlation strength value based at least in part on a cardinality of each column of the correlated pair and the estimated grouping cardinality of the correlated pair at block 326. As used herein, “grouping cardinality” may refer to the number of distinct column pair values for a correlated pair as grouped, rather than the number of distinct values of the pair as paired independent, individual columns. In various implementations, estimating the grouping cardinality of each of the correlated pairs may be performed using a probabilistic counting algorithm or another suitable algorithm. The correlation strength for each of the correlated pairs may be based, in various implementations, on the number of distinct values for the pair as independent, non-correlated paired columns and as grouped, correlated paired columns. For example, in various implementations, determining the correlation strength values may include determining the lower-bound (LV) for grouping cardinality (assuming the pairs are correlated), the upper-bound (HV) for grouping cardinality (assuming the pairs are independent), and the actual grouping (V) cardinality (the actual cardinality). In these implementations, the correlation strength values may be calculated as (HV-V)/(HV-LV). In various implementations, operations 324 and 326 may be limited to correlated pairs having a correlation greater than some predetermined threshold such that only the most correlated pairs are further analyzed. In other implementations, all correlated pairs may be analyzed by operations 324 and/or 326.

The method 300 may proceed with storing in memory correlated pairs having a correlation strength value greater than a predetermined value at block 328. In various implementations, the stored correlated pairs may be referenced later by the database manager or other component of the system to facilitate looking up data, in response to a query, for example. In other implementations, the operation of block 328 may be omitted altogether.

The method 300 may proceed with sorting the plurality of columns from a first position, I=1, to a last position in increasing order of individual cardinality at block 330.

The method 200 may proceed to block 332 by permuting columns of the plurality of columns one-by-one to a second position of the plurality of columns, except for the column at the first position, to determine a first permutation of the plurality of columns having an RLE compression greater than an RLE compression of any other permutation, whereby RLE compression is a factor of grouping cardinalities at each position, the column data types, column width, or correlations, or a combination thereof. In this operation, the first permutation may be determined considering the first column against all remaining columns to find the best match for the second position (i.e., the column that when placed at the second position gives the highest RLE compression of the plurality of columns. In other words, at position I in the sort order, all other columns may be moved one-by-one (except any columns before position which may remain intact) and each resultant sort order may be evaluated for RLE compression.

The method 300 may continue permuting the plurality of columns at block 334. For example, after determining the first permutation, the columns of the first permutation may be permuted one-by-one to a third position of the plurality of columns (I=I+1, i.e., for the next position), except for columns at the second position and any preceding position, to determine a second permutation of the plurality of columns having an RLE compression greater than an RLE compression of any other permutation, and so on. Permuting may continue until reaching a column having an average run-length less than a predetermined run-length threshold at block 336. In various implementations, the operation of block 334 may be performed as it may be desirable to only perform run-length compression on the best candidates having some minimum run length. For example, in some implementations, an RLE threshold may be either 10/N (for a segmented database: N=number of nodes) or 10 (for an unsegmented database). In many implementations, permutations at blocks 332/334/336 may operate like a greedy algorithm such that the next column is compared against only the remaining columns, without backward comparison against columns that have already been determined.

If the next column has an average run-length less than a predetermined less than the predetermined run-length threshold at block 336, the method 300 may proceed to block 338 with compressing the plurality of columns of the final sort order using RLE compression. In various implementations, one or more of the remaining columns (i.e., columns not included in the final sort order) may be compressed using any suitable method or may remain uncompressed.

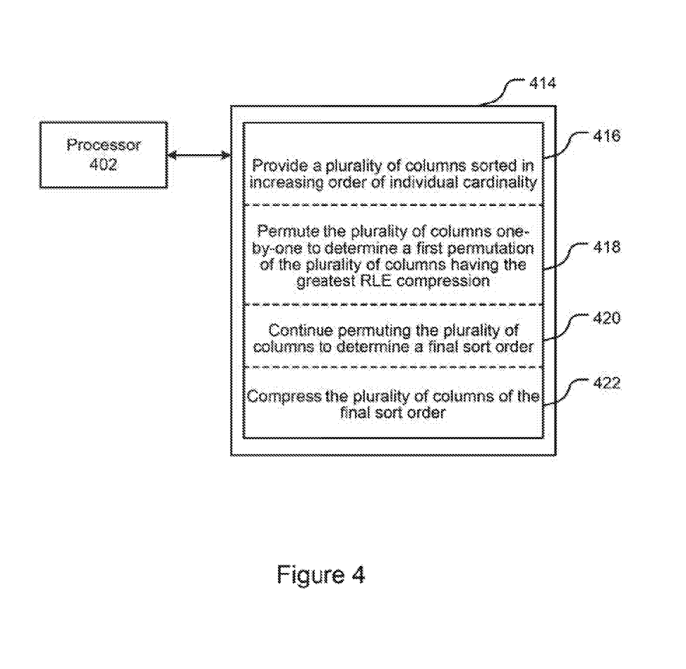

FIG. 4 is a block diagram showing an example non-transitory computer-readable storage medium 414 that stores computer-implemented instructions adapted to implement data compression of the database 106, in accordance with the various methods described herein. The machine-readable medium 414 may correspond to any typical storage device that stores computer-implemented instructions, such as programming code, or the like, that may be executed by the processor 402. The computer-readable media 414 may be or may comprise volatile and/or non-volatile media, such as magnetic media, semiconductor media, and the like.

When read and executed by the processor 402, the instructions stored on the machine-readable medium 414 are adapted to cause the processor 402 to process instructions 416, 418, 420, and 422. A sorter (such as, e.g., the sorter 109 described herein with reference to FIG. 1) may provide a plurality of columns sorted in increasing order of individual cardinality (416). A permutor (such as, e.g., the permutor 110 described herein with reference to FIG. 1) may permute the plurality of columns one-by-one to determine a first permutation of the plurality of columns having the greatest RLE compression (418) and continue permuting the plurality of columns until reaching a column having an average run-length less than a predetermined threshold to determine a final sort order (420). A compressor (such as, e.g., the compressor 112 described herein with reference to FIG. 1) may compress the columns of the final sort order (420).

Although certain implementations have been illustrated and described herein, it will be appreciated by those of ordinary skill in the art that a wide variety of alternate and/or equivalent implementations calculated to achieve the same purposes may be substituted for the implementations shown and described without departing from the scope of this disclosure. Those with skill in the art will readily appreciate that implementations may be implemented in a wide variety of ways. This application is intended to cover any adaptations or variations of the implementations discussed herein. It is manifestly intended, therefore, that implementations be limited only by the claims and the equivalents thereof.

1. A method comprising:
sorting a plurality of columns from a first position to a last position in increasing order of individual cardinality;
permuting columns of the plurality of columns one-by-one to a second position of the plurality of columns, except for the column at the first position, to determine a first permutation of the plurality of columns having a run-length encoding (RLE) compression greater than an RLE compression of any other permutation;
permuting columns of the first permutation one-by-one to a third position of the plurality of columns, except for columns at the second position and the first position, to determine a second permutation of the plurality of columns having an RLE compression greater than an RLE compression of any other permutation;
continuing permuting the plurality of columns to determine a final sort order; and
compressing the plurality of columns of the final sort order using RLE compression.

2. The method of claim 1, wherein said continuing permuting is performed until reaching a column having an average run-length less than a predetermined run-length threshold.

3. The method of claim 1, wherein said permuting the plurality of columns one-by-one to the second position comprises permuting the plurality of columns based at least in part on data type, column width, correlation, or cardinality, or a combination thereof.

4. The method of claim 3, wherein said permuting the plurality of columns of the first permutation one-by-one to the third position comprises permuting the plurality of columns of the first permutation based at least in part on data type, column width, correlation, or cardinality, or a combination thereof.

5. The method of claim 1, further comprising, prior to said sorting the plurality of columns, identifying a plurality of correlated pairs of the plurality of columns.

6. The method of claim 5, further comprising storing in memory correlated pairs having a correlation strength value greater than a predetermined value.

7. The method of claim 6, further comprising determining the correlation strength values of the correlated pairs by:
estimating a grouping cardinality of each pair of the plurality of correlated pairs; and
determining, for each of the correlated pairs, the correlation strength value based at least in part on a cardinality of each column of the correlated pair and the estimated grouping cardinality of the correlated pair.

8. The method of claim 7, wherein said estimating the grouping cardinality of each pair of the correlated pairs comprises using a probabilistic counting algorithm.

9. A system comprising:
a processor;
a storage device to store a database comprising a plurality of columns of data; and
a database manager to manage the database and executable by the processor to:
provide a plurality of columns sorted in increasing order of individual cardinality;
permute columns of the plurality of columns one-by-one to a second position of the plurality of columns, except for the column at a first position, to determine a first permutation of the plurality of columns having the greatest run-length encoding (RLE) compression;
permute columns of the plurality of columns of the first permutation one-by-one to a third position, except for columns at the second position and the first position, to determine a second permutation of the plurality of columns having the greatest RLE compression; and
compress columns at the third position and preceding positions of the second permutation using RLE compression.

10. The system of claim 9, wherein the database manager is executable by the processor to permute columns of the plurality of columns one-by-one to the second position based at least in part on data type, column width, correlation, or cardinality, or a combination thereof.

11. The system of claim 9, wherein the database manager is further executable by the processor to:
identify a plurality of correlated pairs of the plurality of columns;
estimate a grouping cardinality of each pair of the plurality of correlated pairs; and
determine, for each of the correlated pairs, the correlation strength value based at least in part on a cardinality of each column of the correlated pair and the estimated grouping cardinality of the correlated pair.

12. The system of claim 11, wherein the database manager is further executable by the processor to store in memory correlated pairs having a correlation strength value greater than a predetermined value.

13. A non-transitory computer-readable storage medium storing instructions that, when executed by a processor, cause the processor to:
permute columns of a plurality of columns sorted in increasing order of individual cardinality one-by-one to a second position of the plurality of columns, except for the column at a first position of the plurality of columns, to determine a first permutation of the plurality of columns having the greatest RLE compression;
permute columns of the plurality of columns of the first permutation one-by-one to a third position, except for columns at the second position and the first position, to determine a second permutation of the plurality of columns having the greatest RLE compression;
continue permuting the plurality of columns to determine a final sort order; and
compress the plurality of columns of the final sort order using RLE compression.

14. The non-transitory computer-readable storage medium of claim 14, wherein the instructions, when executed by the processors, further cause the processor to:
identify a plurality of correlated pairs of the plurality of columns;
estimate a grouping cardinality of each pair of the plurality of correlated pairs; and
determine, for each pair of the correlated pairs, the correlation strength value based at least in part on a cardinality of each column of the correlated pair and the estimated grouping cardinality of the correlated pair; and
store in memory correlated pairs having a correlation strength value greater than a predetermined value.

15. The non-transitory computer-readable storage medium of claim 14, wherein said continue permuting is performed until reaching a column having an average run-length less than a predetermined run-length threshold.
